(19) United States
(12) Patent Application Publication
(10) Pub. No.: US 2005/0120296 A1
(43) Pub. Date: Jun. 2, 2005

(54) Method and apparatus for processing image data

(76) Inventor: Bruce W. Zeuli, Benicia, CA (US)

Correspondence Address: C. Bart Sullivan, 1543 Sherman Dr., Benicia, CA, 94510, US

(21) Appl. No.: 10/997,248

(22) Filed: Nov. 24, 2004

Related U.S. Application Data
(60) Provisional application No. 60/526,209, filed on Dec. 1, 2003.

(51) Int. Cl. G06F 17/00

(52) U.S. Cl. 715/507

(57) ABSTRACT

An apparatus and method of data entry processing is described. In one embodiment, at least one image having data embedded thereon is displayed in fragmented form to one or more data entry personnel. In one aspect, image fragments associated with at least one data collection form image are displayed in a dissociated arrangement configured to disassociate the context of the at least one data collection form image from the image fragments. In another aspect, a plurality of image fragments are proportionally divided among a plurality of data entry systems in accordance to a data entry workload capability of each of the plurality of data entry systems.

### CROSS REFERENCE TO A RELATED APPLICATION

This invention is based on U.S. Provisional Patent Application Ser. No. 60/526,209, entitled “METHOD AND APPARATUS FOR PROCESSING IMAGE DATA”, filed Dec. 1, 2003 in the name of Bruce W. Zeuli, herby incorporated by reference in its entirety.

### BACKGROUND OF THE INVENTION

1. Field of the Invention

Embodiments of the present invention generally relate to data processing with data entry systems.

2. Description of the Related Art

Data processing of data capture forms such as medical records, insurance forms, and the like, often involves the use of third party data entry personnel or optical character recognition (OCR) software to visually inspect and transfer data images into computer databases for further processing. Conventionally, data entry personnel rely on their language skills and abilities to discern what data characters they are viewing. For example, medical data forms often contain data such as age, height, weight, diagnosis, etc. Data entry personnel view such data and then enter what they interpret from forms into a computer database often by typing the information using a computer keyboard. OCR is often used in lieu of, or to assist, the data entry personnel by matching images of data to known data patterns. Unfortunately, data may be obscured to a point where OCR errors are introduced into the entered data at which point data entry personnel may be used to correct such errors. Data entry personnel are less prone to data error due to their intelligence and adaptability to varying types of image data.

Generally, data entry personnel are trained to enter data they view from a variety of forms and displays. Unfortunately, data input by the data entry personnel may include confidential information such as a credit card numbers, social security numbers, etc. While many data entry personnel keep such sensitive data confidential, some data entry personnel as well as other persons associated with data processing environments that have access to such confidential data may not. Having access to such confidential data may allow unscrupulous individuals, for example, to steal an identity of an individual for personal gain. Often, data entry companies institute programs such as background checks, secure data areas, investigative personnel, etc. to help prevent data stealing. Unfortunately, such data theft prevention measures often work less than adequately. The problem is further exacerbated by data entry personnel housed in offshore facilities operated with inadequate data theft regulations.

One ongoing concern of data entry is effectively matching data entry workload to data entry staff. For example, having too few data entry personnel for a given workload may mean that data entry work may be delayed and include unnecessary errors. However, too many data entry personnel for a given work load increase overhead costs reducing profitability. Virtually all data entry companies struggle with matching the workload to their staff on an ongoing basis. To overcome this issue, many data entry firms often hire data personnel only when needed and then layoff the excess staff when they are not required. While this may work to keep profitability within acceptable levels, it often causes demoralization of such laid off staff that have to cope with variable income and often sporadic work schedules. Additionally, such laid off staff may become less efficient as they are not working consistently.

Therefore, what is needed is a method and apparatus to allow data to be entered while maintaining confidentiality. In addition, a method and apparatus is needed to effectively provide a more even workflow to data entry personnel thereby allowing data entry companies to provide a more consistent work flow to a more consistently sized data entry staff increasing productivity and efficiency.

### SUMMARY OF THE INVENTION

An aspect of the present invention is a method of data entry processing. The method includes receiving at least one image having image data thereon providing at least some context thereto, fragmenting the at least one image into a plurality of image fragments where at least some of the plurality of image fragments has some of the image data thereon. The method includes displaying an arrangement of at least some of the image fragments having some of the image data thereon such that at least some of the context of the at least one image is removed therefrom.

An aspect of the present invention is a method of providing image data to data entry personnel for data entry thereof. The method includes fragmenting at least one image having image data thereon into a plurality of image fragments, wherein some of the image fragments have at least some of the image data and displaying at least some of the plurality of image fragments in an arrangement that conceals at least some context associated with the at least one image.

An aspect of the present invention is a computer readable medium storing a software program that, when executed by a processor of a computer, causes the computer to perform operations of fragmenting at least one image having image data thereon into a plurality of fragmented images, wherein at least some of the fragmented images include some of the image data. The operations include displaying an arrangement of at least some of the fragmented images that removes at least some context associated with the at least one image.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the present invention may admit to other equally effective embodiments.

FIG. 1 is a high-level illustration of one embodiment of a data processing system in accordance with one or more aspects of the present invention.

FIG. 2 is a high-level illustration of one embodiment of data processor of the data processing system of FIG. 1 in accordance with one or more aspects of the present invention.

FIG. 3 is a flow diagram of one embodiment of a method of processing data images in accordance with one or more aspects of the present invention.

FIG. 4 is a high-level illustration of one embodiment of data collection form images in accordance with one or more aspects of the present invention.

FIG. 5 is a high-level illustration of one embodiment of processing data collection form images in accordance with one or more aspects of the present invention.

FIG. 6 is a high-level illustration of one embodiment of processing data collection form images in accordance with one or more aspects of the present invention.

FIG. 7 is a high-level illustration of one embodiment of data structures related to data collection information in accordance with one or more aspects of the present invention.

FIG. 8 is a high-level illustration of one embodiment of data structures related to data collection information in accordance with one or more aspects of the present invention.

FIG. 9 is a high-level illustration of one embodiment of data entry processing in accordance with one or more aspects of the present invention.

FIG. 10 is a high-level illustration of one embodiment of a display of processed collection form data in accordance with one or more aspects of the present invention.

### DETAILED DESCRIPTION OF THE PREFERRED EMBODIMENT

In the following description, numerous specific details are set forth to provide a more thorough understanding of the present invention. However, it will be apparent to one of skill in the art that the present invention may be practiced without one or more of these specific details. In other instances, well-known features have not been described in order to avoid obscuring the present invention.

Aspects of the invention are described in terms of confidential and non-confidential information, concealing information, context associated with information, and fragmenting information. Confidential information is defined herein as information to be protected from unauthorized disclosure. Non-confidential information is information not to be protected from unauthorized disclosure. Concealing information is defined herein to keep information from being seen, observed, or discovered. Context is defined herein as information associated with a contextual environment, such as a document, that combined with surrounding information, imparts an associated contextual meaning. For example, consider the case of a confidential sentence stating “Mr. Smith has terminal cancer”. Such a confidential sentence contextually associates such an individual “Mr. Smith” with the diagnosis of “terminal cancer”. Disassociating such contextually associated terms changes a contextual meaning. For example, in this case concealing “Smith” from such sentence “Mr. Smith has terminal cancer”, changes the contextual nature of the sentence from it original confidential state to a non-confidential state. Fragment is defined herein as disassociating a word, phrase, image, symbol, data field, and the like, associated with a contextual environment such as a document, form, etc., from its original contextual environment in order to remove at least some associated contextual meaning therefrom.

As will be described below, aspects of one embodiment pertain to specific method steps implementable on computer systems. In one embodiment, the invention may be implemented as a computer program-product for use with a computer system. The programs defining the functions of at least one embodiment can be provided to a computer via a variety of computer-readable media (i.e., signal-bearing medium), which include but are not limited to, (i) information permanently stored on non-writable storage media (e.g. read-only memory devices within a computer such as read only CD-ROM disks readable by a CD-ROM or DVD drive; (ii) alterable information stored on a writable storage media (e.g. floppy disks within diskette drive or hard-disk drive); or (iii) information conveyed to a computer by communications medium, such as through a computer or telephone network, including wireless communication. The latter specifically includes information conveyed via the Internet. Such signal-bearing media, when carrying computer-readable instructions that direct the functions of the invention, represent alternative embodiments of the invention. It may also be noted that portions of the product program may be developed and implemented independently, but when combined together are embodiments of the invention.

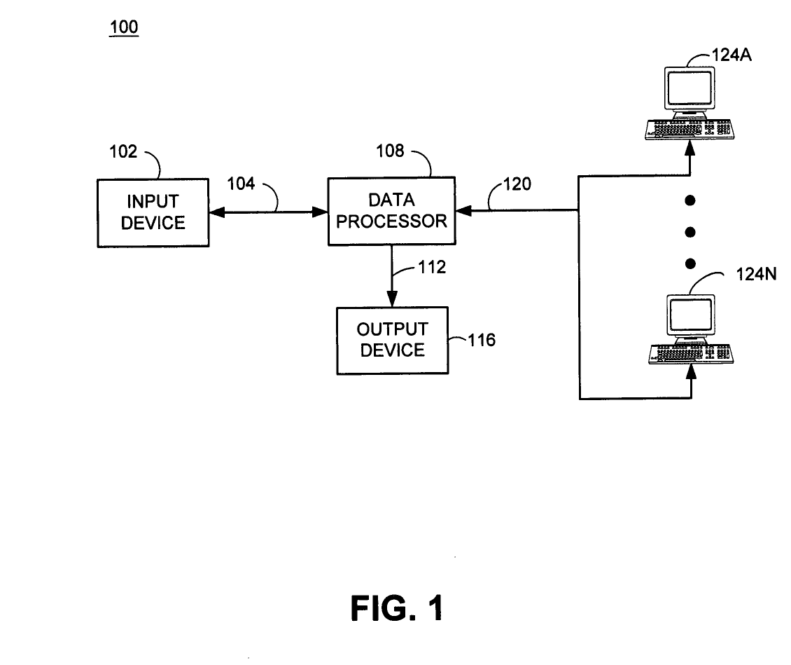

FIG. 1 is a high-level illustration of one embodiment of a data processing system 100 in accordance with one or more aspects of the present invention. Data processing system 100 includes at least one data processor 108 in communication with one or more data entry terminals 124A-N via transmission connection 120, where data entry terminal 124N is indicative of an “N” number of terminals. Data entry terminals 124A-N may be selected from virtually any data entry terminal 124A-N that may be used to advantage such as computer terminals, network terminals, and the like. Transmission connection 120 may be configured from a plurality of interconnections such as telephone wires, cables, twisted pair, and others, including wireless connections, adapted to provide a communication connection. Transmission connection 120 may be configured to operate as a network such as a peer-to-peer network, Local Area Network (LAN), Wide Area Network (WAN), and the like. Transmission connection 120 may be configured as a hard wired connection using interconnection standards such as IEEE 1394, Universal Serial Bus (USB), and the like, or wireless connection using standards such as 802.11, blue tooth, and the like. Transmission connection 120 may be configured to work over a larger network connection such as the Internet.

In one aspect of the present invention, data processor 108 is configured to receiver image data from at least one input device 102. The input device 136 can be any device configured to give input to the data processing system 100. For example, a keyboard, keypad, light-pen, touch-screen, track-ball, or speech recognition unit could be used. In one aspect, input device 102 may include one or more imaging devices configured to provide an image of an object such as a data collection form such as insurance forms, medical forms, etc. Such input device 102 may include data imaging systems such as scanners, digital cameras, and the like configured to capture images from forms, photos, etc. Input device 102 may include other types of data capture systems such as digital signature terminals, fingerprint devices, x-ray machines, reflective image processing systems, sonic imaging devices (ultrasound), blue print machines, copiers, fax machines, personal data devices (PDA), personal hand-held computers, electronic writing tablets, and the like. Such input device 102 may be configured to process data derived from software based image generation such as computer aided drawing (CAD) software, bitmap software, paint software, and virtually any type of image conversion software such as optical character recognition (OCR) that converts images to electronic data.

Data processor 108 may provide data to output device 116 via bus 112 in response to data received from at least one input device 102. Output device 116 is preferably any conventional display screen and, although shown separately from input device 102, output device 116 and input device 102 could be combined. For example, a display screen with an integrated touch-screen, and a display with an integrated keyboard, or a speech recognition unit combined with a text speech converter could be used.

In one operational aspect, images from one or more data collection forms are processed by input device 102 and transmitted to processor 108. Data processor 108 provides a display of image data associated with such data collection forms to data entry personnel via data entry terminals 124A-N. Such image data display may be arranged to remove at least some contextual association between a respective data collection form and image data display. Data entry personnel view, interpret, and enter such image data display into data entry terminals 124A-N. Data processor 108 processes such entered data and may provide a display therefrom having at least some association between a respective data collection form and such entered data to an end user, for example, via output device 116 as described further below.

FIG. 1 is merely one configuration for data processing system 100. Embodiments of the present invention can apply to any comparable configuration, regardless of whether the data processing system is a complicated multi-user apparatus, a single-user workstation, or network appliance that does not have non-volatile storage of its own.

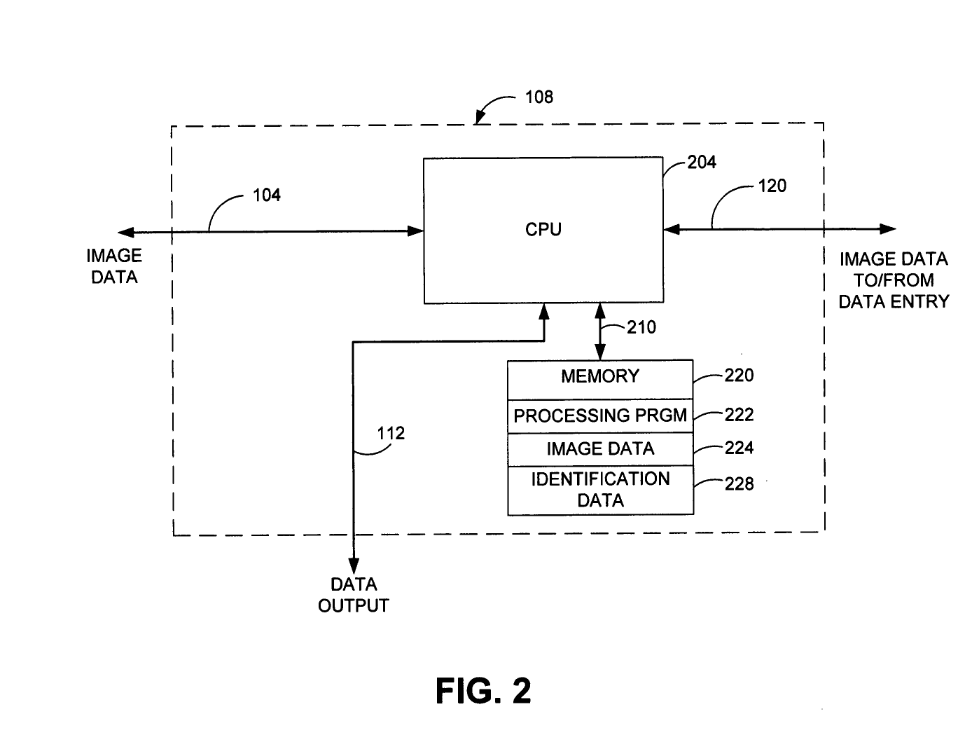

FIG. 2 is a high-level illustration of one embodiment of data processor 108 of the data processing system 100 of FIG. 1 in accordance with one or more aspects of the present invention. In one aspect, data processor 108 includes Central Processing Unit (CPU) 204 and memory 220. The CPU 204 may be under the control of an operating system that may be disposed in memory 220. Virtually any operating system supporting the configuration functions disclosed herein may be used. Memory 220 is preferably a random access memory sufficiently large to hold the necessary programming and data structures of the invention. While memory 220 is shown as a single entity, it should be understood that memory 220 may in fact comprise a plurality of modules, and that memory 220 may exist at multiple levels, from high speed registers and caches to lower speed but larger direct random access memory (DRAM) chips.

Illustratively, memory 220 may include data processing program 222 that, when executed on CPU 204, controls at least some operations of data processing system 100. Processing program 222 may use any one of a number of different programming languages. For example, the program code can be written in PLC code (e.g., ladder logic), a higher-level language such as C, C++, Java, or a number of other languages. While processing program 222 may be a standalone program, it is contemplated that processing program 222 may be combined with other programs.

In one aspect, memory 220 may include image data structure 224. Image data structure 224 may include a plurality of images of data used, for example, to display to an end user via output device 116 and data entry terminals 124A-N as described below. In another aspect of the present invention, memory 220 may include identification data structure 228. Identification data structure 228 may be used to associate images of data to other data used to identify such images of data as described herein.

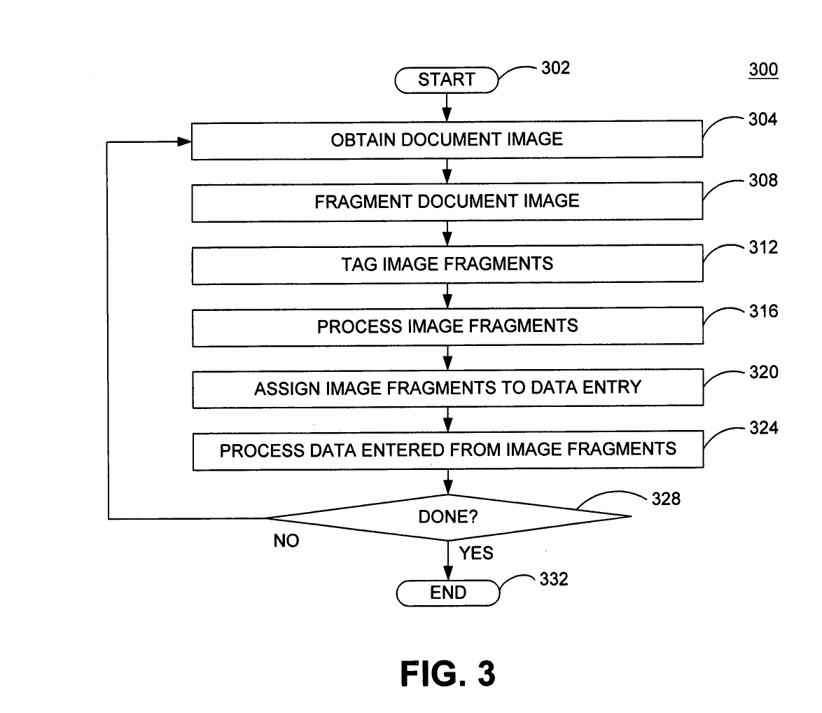

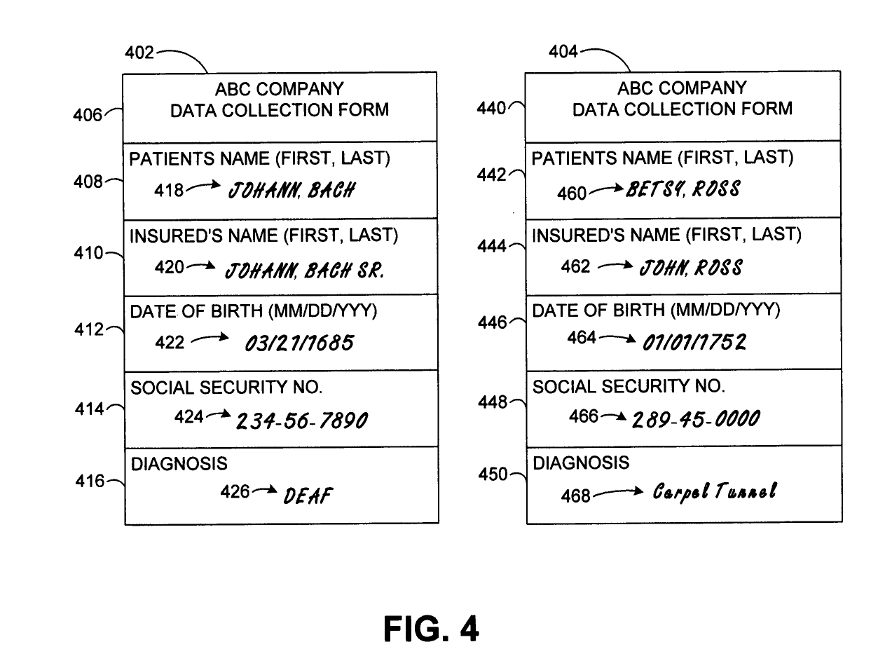

FIG. 3 is a flow diagram of one embodiment of a method 300 of processing data images in accordance with one or more aspects of the present invention. Method 300 is entered into for example when processing program 222 is activated. At 304, at least one document image is obtained. For example, input device 102 may be configured to scan a document such as a medical record form and transmit the resultant image data to data processor 108 via transmission signal 104. At 308, at least some of one or more non-searchable data images, such as an insurance form for example, are fragmented into a plurality of separate images, i.e. image fragments some of which are as described below with respect to FIGS. 4-9.

At 312, such image fragments are associated with at least one unique identifying number. Such at least one unique identifying number may be derived using one or more algorithms or processes configured to assign a unique identity to each separate image fragment. For example, a random number generator may be used to generate a random unique identification number for an image fragment. For purposes of clarity, unique identifying numbers are discussed. However, it is contemplated that virtually any methodology or system configured to identify an image may be used. For example, one or more separate image fragments may be identified using identification techniques such as color-coding, image pattern tattooing, watermarks, and other methods of uniquely identifying images. Such image fragments are processed to place them into a desired display order at 316. For example, such image fragments may be randomly assigned a display order. Such image fragments may also be assigned in a particular defined order. Such a particular order may be correlated to a number of different data entry locations. Consider the case where each data form contains five data fields of information. Such data fields may be “name”, “address”, “social security number”, “telephone”, and “address”, for example. Each data field may be directed to a different data entry location. Therefore, five data entry locations may be used where one data entry location may data enter names, while another data entry location may enter addresses, and so forth. Each data entry location may be separated from one another in a variety of ways. Such data entry location may be disposed in separate geographical locations such as different parts of a building, different buildings, different cities, or even different countries, and so forth.

At 320, at least some of the fragmented images are assigned to two or more locations. While two or locations may be used, it is contemplated that one location may be used where by the fragmented images are randomly displayed to the one location, for example. In addition, fragmented images may include one or more “seeded” bogus image fragments. Such bogus image fragments may be used to further contextually disassociate fragmented data from an original data source. For example, for a data form only having two data fields to process such as a credit card number and expiration date, bogus credit card numbers may be combined within actual credit card number images to further disassociate a particular credit card number with a particular expiration data. Further, such bogus information may be used to detect fraud. For example, if a bogus credit card number is used externally to a data entry location, an association may be established between the bogus credit card number and the data entry location. Such an association may be used by, for example, by data theft investigators to help determine who is responsible for disclosing such bogus credit card information to individuals unauthorized to utilize such data.

At 324, at least some image fragments are transmitted to one or more data entry locations for data entry processing therefrom. For example, a plurality of image fragments having non-searchable data from a plurality of forms, such as a medical record forms filled out by a plurality of patients, are sent to one or more data entry locations for data processing thereof. At such data entry locations, data entry personnel view, interpret, and enter data associated with at least some image fragments into data gathering systems such as data processing system 100. At 328, method 300 checks to see if such data entry processing is done. If data entry processing is finished, method 300 ends at 320. If however, data entry processing is not finished, method 300 returns to 304.

### OPERATIONAL EXAMPLE

FIG. 4 is a high-level illustration of one embodiment of data collection form images 402,404 in accordance with one or more aspects of the present invention. For purposes of clarity, data collection form images 402 and 404 are described in terms of data collection forms configured to collect confidential and non-confidential data from individuals. However, it is contemplated that such data collection forms may be derived from a plurality of different sources used to collect confidential and non-confidential data having at least some context such as may be found on proprietary drawings, figures, sketches, artwork, printed circuit layouts, software code, signs, posters, photographs, and the like.

Data collection form images 402,404 may be derived from virtually any type of form, having at least some non-searchable data such as data embedded thereon and integral thereto that is image processed for example by input device 102. In one aspect of the present invention, data form images 402,404 may be derived from data collection forms such as medical record forms, insurance forms, mortgage qualification forms, credit card information collection forms, warranty cards, and the like having confidential and non-confidential data embedded thereon contextually associated with each of such data collection forms. For example, a medical record form may include one or more embedded data that is contextually associated with a patient, e.g., a medical patient filled out a medical data collection form with medical information about himself or herself. Data disposed thereon such forms is generally formed using external data entry processes such as handwriting, typewriting, stamping, painting, drawing, printing, stenciling, silk screening, photography, and the like. Data may also be created using other methods such as printing a document entered into a user's computer. For example, a user may fill out a data collection form in a word processor and scan such a data collection form to create data collection form image 402,404.

In one embodiment, data collection form images 402 and 404 provide at least some context associated with data thereon to persons viewing such forms 402,404. For example, personnel visually inspecting such data collection forms 402 and 404 may contextually associate fields of such data collection form images 402,404 to the data collection form 402,404 being visually inspected. In one aspect, data collection forms 402 and 404 may be data collection forms used to derive personal information from individuals. Illustratively, data collection form 402 may be a confidential medical information collection form that includes data fields such as company field 406, patient's name field 408, insured's name field 410, date of birth data field 412, social security data field 414, and diagnosis data field 416. Data collection form 404 may be another medical information collection form which includes data fields such as company field 440, patient's name field 442, insured's name field 444, date of birth data field 446, social security data field 448, and diagnosis data field 450.

Illustratively, data collection form images 402 and 404 include handwritten data embedded thereon. For example, data collection form image 402 includes patient's name field 408 having a handwritten “Johann, Bach” 418 data entry, insured's name field 410 having a handwritten “Johann, Bach Sr.” 420 data entry, and date of birth data field 412 having a handwritten “Mar. 27, 1685” 422 data entry. Data collection form image 402 also includes a handwritten social security number “234-56-7890” disposed within social security data field 414, and a handwritten diagnosis of “Deaf” 426 disposed in diagnosis field 416.

Data collection form image 404 includes patient's name field 440 having a handwritten “Betsy, Ross” 460 data entry, insured's name field 444 having a handwritten “John, Ross” 462 data entry, and date of birth data field 446 having a handwritten “Jan. 1, 1752” 464 data entry. Data collection form image 404 also includes a handwritten social security number “289-45-000” disposed within social security data field 448, and a handwritten diagnosis of “Carpel Tunnel” 468 disposed in diagnosis field 450.

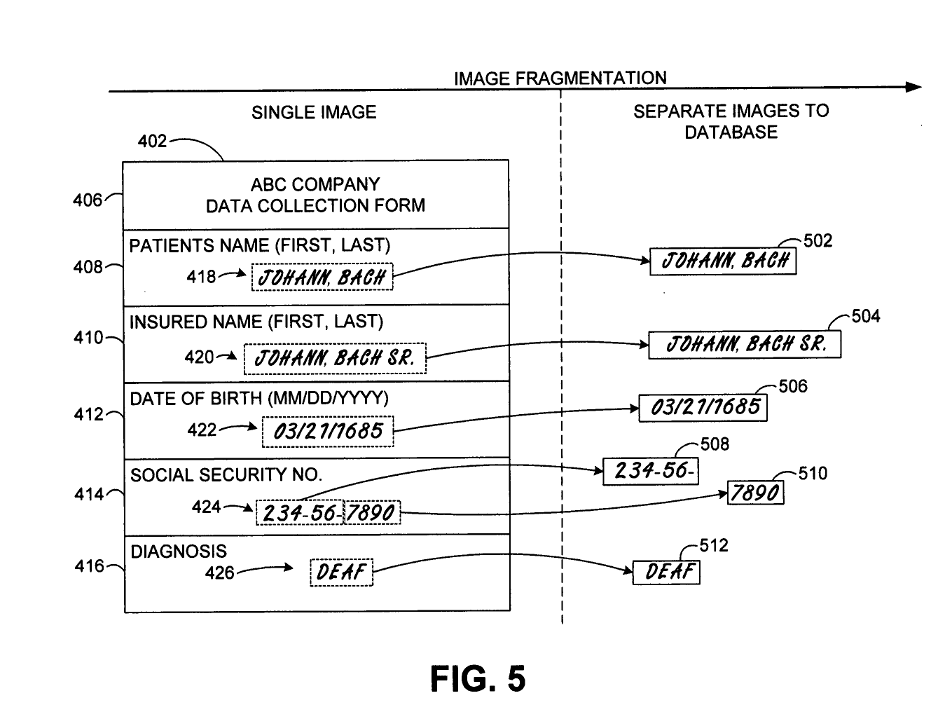

FIG. 5 is a high-level illustration of one embodiment of processing data collection form images 402,404 in accordance with one or more aspects of the present invention. For purposes of clarity, FIG. 5 is described in terms of imaging image data with respect to a fixed imaging region size relative each data field 406-416 e.g., imaging regions may have a fixed width and length. However it is contemplated that imaging region sizes may be variable. For example, imagining regions may be dynamically sized such that imaging system such as found in input device 102 may image only certain areas of a data collection form image region being imaged having a predetermined change in contrast, shade, color, printing, etc.

FIG. 5 illustrates data collection form 402 being image processed by for example, data processor 108 to fragment data collection form image 402 into a plurality of image fragments 502-512. In one aspect of the present invention, data collection form image 402 is imaged within a section of each data field 408-416 to derive at least one image fragment 502-512 associated with data 418-426 embedded thereon. For example, patient's name field 408 is imaged to derive handwritten “Johann, Bach” data entry 418 as a separate image fragment 502. Insured's name field 410 is imaged to provide handwritten “Johann, Bach Sr.” data entry 420 as an image fragment 504. Date of birth data field 412 is imaged to derive handwritten “Mar. 27, 1685” data entry 422 as image fragment 506.

To further remove context from data 418-426 within each field 408-416, an imaging process may image more than one region within a data entry field 408-416. For example, only part of handwritten social security number “234-56-7890” 424 disposed within social security data field 414 is imaged to derive a partial social security number “234-56-” as image fragment 508. Further, another part of handwritten social security number “234-56-7890” 424 disposed within social security data field 414 is imaged to derive a partial social security number “7890” as image fragment 510. Thus, in this embodiment, a data collection image 402 is imaged processed to derive one or more image fragments 502-512 therefrom.

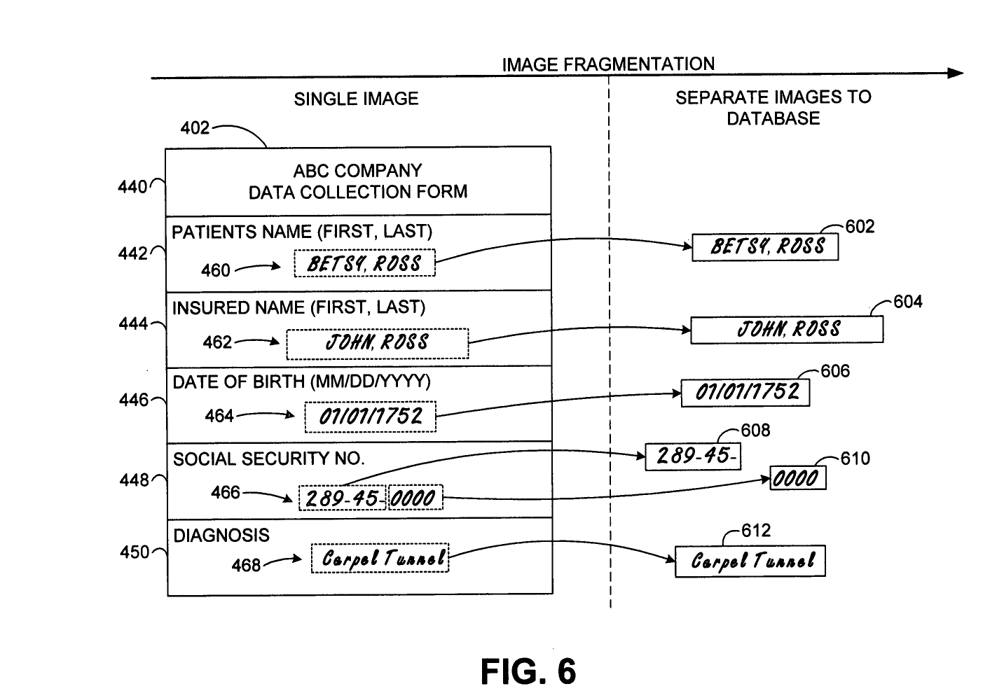

FIG. 6 illustrates data collection form 404 being image processed by for example, data processor 108 to fragment data collection form image 404 into a plurality of image fragments 602-612. In one aspect of the present invention, data collection form image 404 is imaged within a section of each data field 440-450 to derive at least one image fragment associated with image data 460-468 embedded thereon. For example, patient's name field 442 is imaged to derive handwritten “Betsy, Ross” data entry 460 as a separate image fragment 602. Insured's name field 444 is imaged to provide handwritten “John, Ross” data entry 462 as an image fragment 604. Date of birth data field 448 is imaged to derive handwritten “Jan. 1, 1752” data entry 464 as image fragment 606.

To further remove context from data 460-468 within each field 440-450, an imaging process may image several sections within a data entry field 440-450 to provide a plurality of fragmented images therefrom. For example, only part of handwritten social security number “289-45-0000” 466 disposed within social security data field 448 is imaged to derive partial social security number “289-45-” as image fragment 608. Further, another part of handwritten social security number “289-45-0000” 466 disposed within social security data field 448 is imaged to derive partial social security number “0000” as image fragment 610. Thus, in this embodiment, data collection image 404 is imaged processed to derive one or more image fragments 602-612 therefrom.

In summary, FIG. 5 and FIG. 6 illustrate an image process whereby a single image is processed by an imaging system 100 to derive a plurality of fragmented images of data derived from data collection forms, for example. In one aspect, such imaging system 100 may be configured such that image fragments, e.g., image fragment 504, from at least one single data entry, such as a “name” data entry 418, for example, may be image fragmented until such data entry loses contextual meaning associated with source data collection form image 402,404. For example, image fragmenting a name image data “Bruce” to remove “Bu” from “Bruce” data creates two separate image data “Br” and “uce” that when separated from one another removes a contextual meaning that “Br” means “Bruce” as “Br” may be indicative of other words such as “Brown”, “Brush”, “Brian”, “Brad”, etc. In addition, while imaging system 100 may derive a plurality of fragmented images of data derived from images of data collection forms, for example, imaging system 100 may process such data collection form images 402,404 to conceal at least some context from data entry personnel. For example, data collection form 402 may be processed to conceal a social security number from view by one data entry personnel, and then provide a second data collection form 402 that discloses at least the social security number to another data personnel.

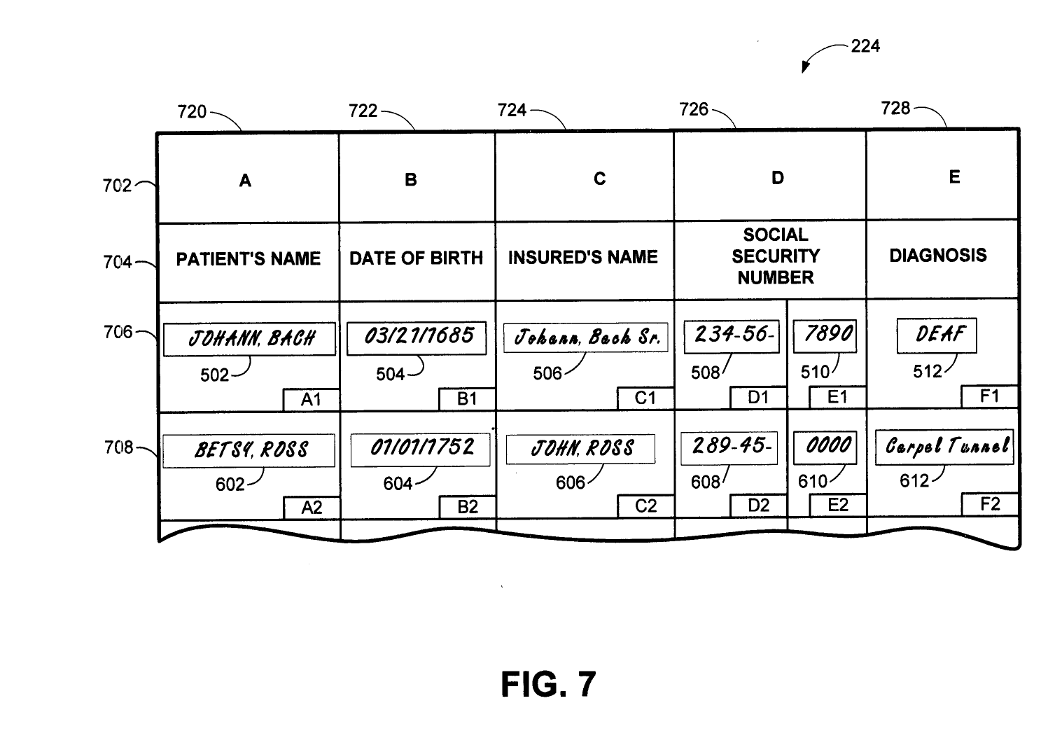

FIG. 7 is a high-level illustration of one embodiment of a data structure 224 related to data collection information in accordance with one or more aspects of the present invention. In one aspect of the present invention, data structures 224 include reference header row 702 and data description row 704. Data structure 224 also include one or more data rows 706,708. Illustratively, data structure 224 includes data row 706 that includes image fragments 502-512 stored therein from data collection form image 402. Data structure 224 includes data row 708 that includes image fragments 602-612 stored therein from data collection form image 404 (See FIG. 4). Data structure 224 includes at least one data column 720-728 configured to store at least one fragmented image data. For example data column 720 includes column descriptor of “A” that is associated with a name image data in column 720. Data column 772 includes column descriptor “B” associated with date of birth image data for each patient name in a respective data row 706-708. Data column 724 includes a column descriptor “C” associated with an insured's name image data for each patient name within a respective data row 706-708. Data column 726 includes column descriptor “D” associated with a social security number image data for each patient name within a respective data row 706-708. Data column 728 includes column descriptor “E” associated with a diagnosis image data for each patient name within a respective data row 706-708.

In one aspect, one or more image fragments 502-512 and 602-612 may be associated with a respective data row 706-708 and data column 720-728. In one configuration, image fragments 502-512 from data collection form image 402 are stored in a data row 706 and data column 720 an assigned a unique data location identifier. For example, image fragment 502 is assigned data location identifier A1 indicative of data row 706 and data column 720. Other image fragments 504-512 are similarly stored and identified. For example, image fragment 504 may be stored in data row 706 and data column 722 an assigned data location identifier B1.

Image fragments 602-612 from data collection form image 404 are stored in a data row 708 and data columns 720-728 an assigned a unique data location identifier. For example, image fragment 602 is stored in data location number A2 indicative of data row 708 and data column 720. Other image fragments 604-612 are disposed similarly. For example, image fragment 604 is stored in data row 708 and data column 722 an assigned data location identifier B2. In summary, at least some image fragments 502-512 are stored in data row 706 and assigned a respective data location identifier such as identifier A1 through F1, for example. At least some image fragments 602-612 are stored in data row 708 and assigned a respective data location identifier such as identifier A2 through F2, for example.

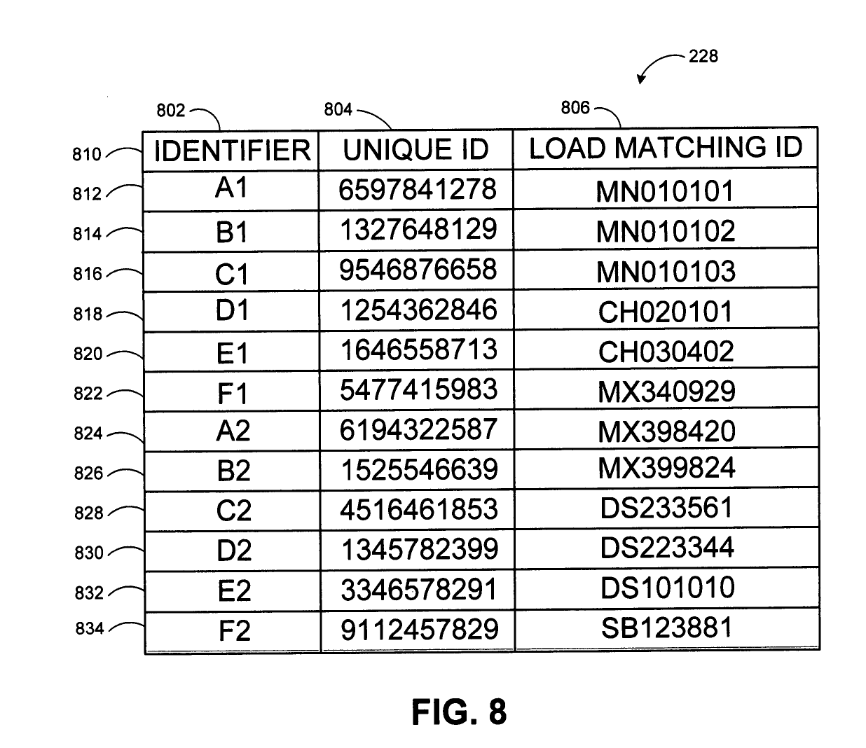

FIG. 8 is a high-level illustration of one embodiment of a data structure 228 related to data collection information in accordance with one or more aspects of the present invention. Illustratively, data structure 228 includes header row 810 and a plurality of data rows 810-832. Data structure 228 includes data column 802, data column 804, and data column 806. Data column 802 may be configured to store an image fragment identifier, e.g., A2, therein. For example, identifier A1 may be stored in data column 802 and row 810, further B1 may be stored in data column 802 and row 812, and so forth. Data column 804 may be configured to store a unique identification number assigned to each identifier A1-F2. Unique identification numbers may be derived several ways. For example, unique identification numbers may be randomly generated numbers. In one aspect, unique identification numbers are randomly assigned to a respective identifier A1-F2. For example, with respect to data row 810, data column includes identifier “A1” and unique identification number “6597841278”.

In one aspect, column 806 associates a workload matching identifier to a respective identifier A1-F2. Workload matching identifiers may be used to more equally distribute data entry work to a plurality of data entry terminals 124A-N. For example, consider the case where three data entry companies have ten data entry terminals 124A-N each and are not staffed to meet a data entry demand for more than ten data entry personnel each for a given data entry schedule, unless they hire more data entry personnel. If image fragments 502-512 and 602-612 require more than ten data entry personnel to finish the work on such schedule, workload matching identifiers may be configured to associate a portion of image fragments 502-512 and 602-612 to each company thereby “sharing” the work load amongst each data entry company relative to their data entry capacity. This is especially advantageous when for example several companies have significantly different workload capabilities and often have to change staffing to match such workload capabilities to meet data entry demand. Thus in summary, processing system 100 fragments image data into a plurality of image fragments 502-512 and 602-612. Such image fragments 502-512 and 602-612 may be stored in a respective location A1-F2 in memory 220. Image fragments 502-512 and 602-612 may then be assigned a unique identification number 804 and a workload matching identifier 806.

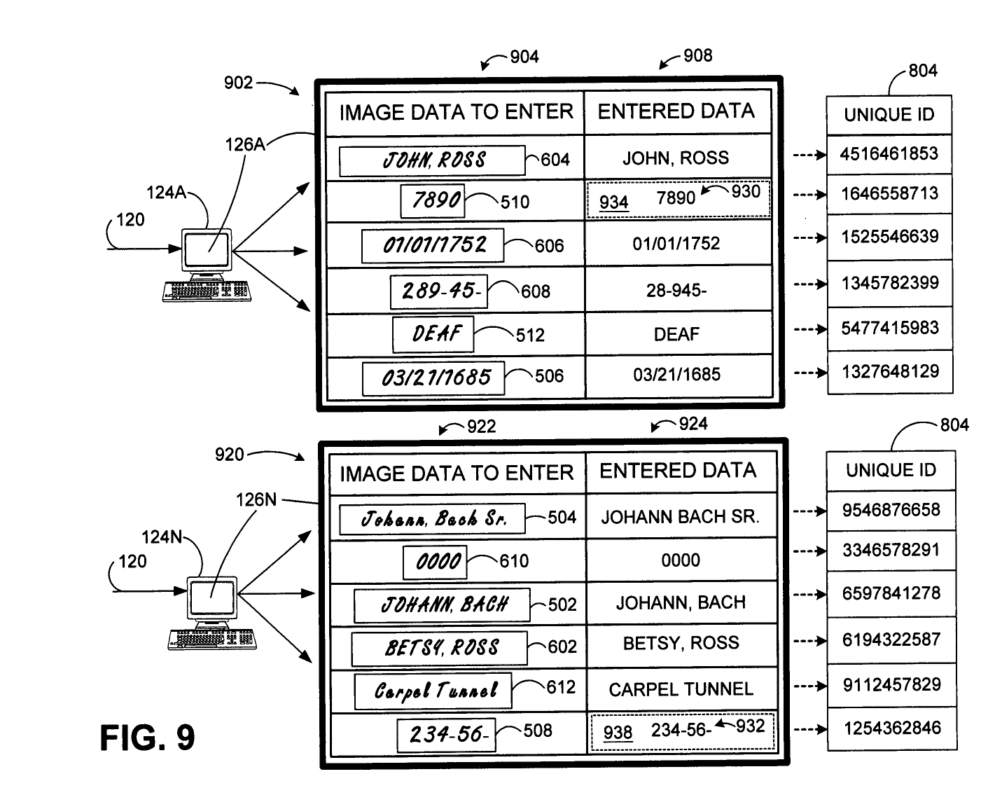

FIG. 9 is a high-level illustration of one embodiment of data entry processing in accordance with one or more aspects of the present invention. For purposes of clarity, image fragments 502-512 and 602-612 are described in terms of unaltered images. However, it is contemplated that such image fragments 502-512 and 602-612 may be further image processed to distort such image fragments 502-512 and 602-612 from being visually associated. For example, such image fragments 502-512 and 602-612 may be visually distorted using techniques such as enlargement, stretching, shading, and the like, to remove image association between two or more image fragments 502-512 and 602-612.

Illustratively, data entry terminals 124A-N includes a respective data entry display screen 126A-N. For example, data entry display screen 124A may provide data entry personnel data entry view 902. Data entry view 902 includes, for example, image data to enter 904 on one side of the display screen 124A, and data entered 908 by such a data entry personnel using data entry terminal 124A on an adjacent side of display screen 124A. Data entry view 902 may include a plurality image fragments 502-512 and 602-612 corresponding to their unique identification number 804 and dissociated assignment to data entry terminal 124A. For example, as illustrated in data entry view 902, a dissociated display of image data to enter 904 for data entry terminal 124A includes name image fragment 604, partial social security number image fragment 510, birth date image fragment 606, partial social security number image fragment 608, diagnosis image fragment 512, and birth date image fragment 506. Further, as illustrated in data entry view 920, a dissociated display of image data to enter 922 for data entry terminal 124N includes insured's name image fragment 504, partial social security number image fragment 610, name image fragment 502, name image fragment 602, diagnosis image fragment 612, and partial social security number image fragment 508. Therefore, as such plurality image fragments 502-512 and 602-612 are dissociated in display assignment, data entry personnel are bared from associating such plurality image fragments 502-512 and 602-612 to one another and therefore are bared from associating such image fragments 502-512 and 602-612 to a particular data collection form image 402,404. Further, without data collection form images 402 and 404, others associated with such data entry processing are barred from associating such plurality image fragments 502-512 and 602-612 to one another and therefore are bared from associating such image fragments 502-512 and 602-612 to a particular data collection form image 402,404.

In one aspect, bogus image fragments (not shown) may be used to further discourage associating such image fragments 502-512 and 602-612 to a particular data collection form image 402,404. For example, if two or more data entry personnel are collaborating in an attempt to associate image fragments 502-512 and 602-612, such bogus fragments may be used to discourage such collaboration by identifying the collaborators. For example, such bogus fragments may lead investigators to such unscrupulous data entry personnel. Further, when such unscrupulous data entry personnel are discovered, they may provide knowledge to others considering such collaboration that attempting such collaboration may get them into trouble.

In one operational embodiment, data entry personnel view, interpret, and enter data from such image data 502-512 and 602-612 accordingly into a corresponding entry field of enter data view 908,924. For example, at data entry terminal 124A partial social security number image fragment 510 having a partial social security number of 7890 associated with image data 424 is viewed, interpreted, and may be entered as data entry “7890” 930 by data entry personal into data entry field 934. At another data entry terminal 124N, social security number image fragment 508 having a partial social security number of “234-56-” also associated with image data 424 is viewed, interpreted, and may be entered as data entry “234-56-” 932 by another data entry personal into data entry field 938.

In summary, a respective data entry personnel observes, interprets, and enters such image data fragments 502-512 and 602-612 on their respective data entry terminals 124A-N. Each of the image data fragments 502-512 and 602-612 are assigned in a disassociated order to different data entry terminals 124A-N to dissociate the context of image data fragments 502-512 and 602-612 from the context of each other and of the data collection form images 402 and 404. Such contextual dissociation bars data personnel from contextually associating such data to each other and either data collection image 402 and 404 thereby maintaining data confidentiality.

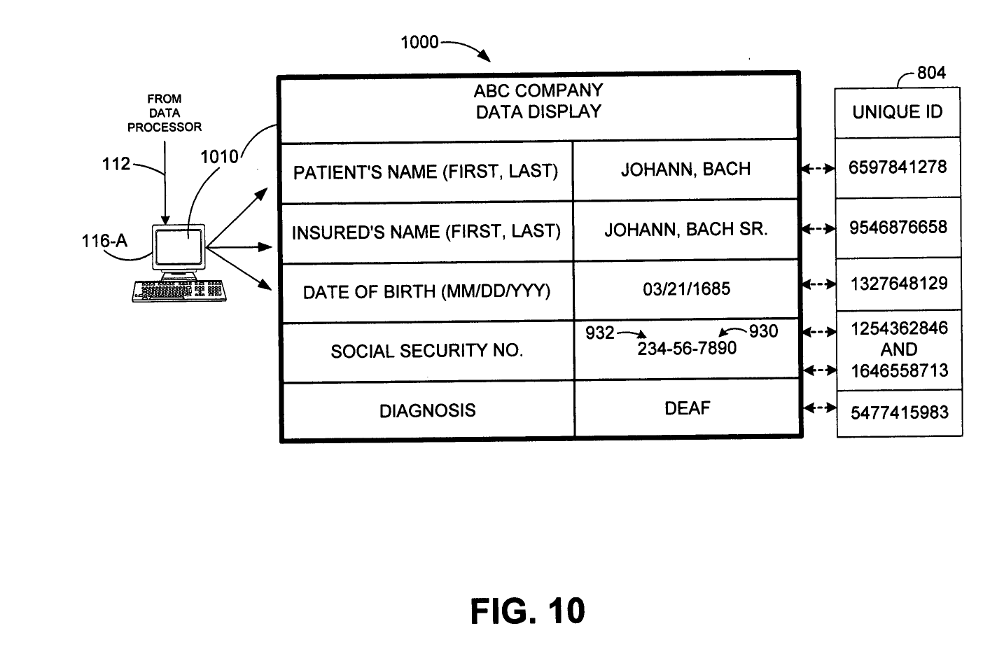

FIG. 10 is a high-level illustration of one embodiment of a display 1000 of processed collection form data in accordance with one or more aspects of the present invention. Illustratively, an output device 116 may be configured as a visual display terminal 1010 such on a computer monitor 116-A. In one operational embodiment, once data entry personal have viewed interpreted, and entered image data to enter 904,922 as illustrated in FIG. 9, such entered data 908,924 is stored in memory 220 as described herein. Processing system 108 may be configured by an end user, for example, to associate and display such entered data 908,924 stored in memory 220 for one or more data collection images 402, 404.

In one aspect, display 1000 illustrates a searchable database display 1020 of data collection form image 402. With reference to FIG. 9, to display entered data 908,924 associated with a respective data collection image, i.e., patient, processing system 108 retrieves and associates entered data 908,924 relative to unique identification numbers stored in memory 220. For example, to display the full social security number of “234-56-7890” from collection image data 424, social security image fragment 510 having entered data of “7890” and social security image fragment 508 having entered data of “234-56-” are retrieved from memory 220 using respective unique identification numbers. Such entered social security image data are then combined and displayed on computer screen 116-A as social security data “234-56-7890”.

While the foregoing is directed to embodiments of the present invention, other and further embodiments of the invention may be devised without departing from the basic scope thereof, and the scope thereof is determined by the claims that follow.

1. A method of data entry processing, comprising:
receiving at least one image having image data thereon providing at least some context thereto;
fragmenting the at least one image into a plurality of image fragments wherein at least some of the plurality of image fragments has some of the image data thereon; and
displaying an arrangement of at least some of the image fragments having some of the image data thereon such that at least some of the context of the at least one image is removed therefrom.

2. The method of claim 1, wherein image data comprises at least some non-searchable image data.

3. The method of claim 1, wherein receiving at least one image comprises imaging at least one document having at least some non-searchable data thereon to form the at least one image.

4. The method of claim 3, wherein imaging comprises imaging techniques selected from at least one of scanning, printing, photographing, and combinations thereof.

5. The method of claim 1, wherein fragmenting the at least one image comprises generating individual images from at least some portion of the image data to provide the image fragments.

6. The method of claim 1, wherein displaying an arrangement of at least some of the image fragments comprises randomly displaying at least some of the image fragments having some of the image data thereon.

7. The method of claim 1, further comprising providing an amount of the plurality of image fragments to a plurality data entry systems that matches each of the plurality data entry systems data entry capability within a predetermined data entry capability range.

8. A method of providing image data to data entry personnel for data entry thereof, comprising:
fragmenting at least one image having image data thereon into a plurality of image fragments, wherein some of the image fragments have at least some of the image data and displaying at least some of the plurality of image fragments in an arrangement that removes at least some context associated with the at least one image.

9. The method of claim 8, wherein the at least one image comprises at least some embedded data thereon.

10. The method of claim 8, wherein the fragmenting at least one image comprises fragmenting at least one image data having context into other image fragments until a context of the at least one image data is dissociated from the at least one image data.

11. The method of claim 8, wherein the fragmenting at least one image comprises imaging at least a portion of the at least one image to capture at least one image fragment.

12. The method of claim 8, wherein displaying at least some of the plurality of image fragments comprises randomly displaying at least some of the plurality of image fragments to different data entry terminals.

13. The method of claim 8, wherein the plurality of image fragments comprises at least one bogus image fragment.

14. The method of claim 8, further comprising determining a data entry work load capability of a plurality of data entry systems and adjusting the display of the plurality of image fragments such that a data work load is proportionally spread amongst the plurality of data entry systems within a desired range of workload for each data entry system.

15. A computer readable medium storing a software program that, when executed by a processor of a computer, causes the computer to perform an operation comprising:
fragmenting at least one image having image data thereon into a plurality of fragmented images wherein at least some of the fragmented images include some of the image data; and
arranging one or more displays of at least some of the fragmented images that removes at least some context associated with the at least one image.

16. The computer readable medium of claim 15, wherein the at least one image comprises at least some embedded data thereon that is associate with the context associated with the at least one image.

17. The computer readable medium of claim 16, wherein fragmenting at least one image comprises determining at least one image data thereon to process into at least one image fragment.

18. The computer readable medium of claim 16, wherein fragmenting at least one image having image data thereon into a plurality of fragmented images comprises fragmenting at least one image data fragment having a context associated therewith until the context is disassociated from the at least one image data fragment.

19. The computer readable medium of claim 16, wherein fragmenting at least one image comprises generating at least one image fragment having at least some embedded data thereon that is contextually disassociated from the at least one image when observed separately therefrom.

20. The computer readable medium of claim 16, wherein arranging one or more displays of at least some of the fragmented images comprises sorting some of the plurality of fragmented images displayed into a random order.
